(19) United States
(12) Patent Application Publication
(10) Pub. No.: US 2025/0281915 A1
(43) Pub. Date: Sep. 11, 2025

(54) Synthesis of Metallic Glass Nanoparticles by Flash Carbothermic Reactions and Compositions Thereof

(71) Applicant: WILLIAM MARSH RICE UNIVERSITY, Houston, TX (US)

(72) Inventors: James M. TOUR, Houston, TX (US); Bing DENG, Houston, TX (US)

(73) Assignee: WILLIAM MARSH RICE UNIVERSITY, Houston, TX (US)

(21) Appl. No.: 18/735,513

(22) Filed: Jun. 6, 2024

Related U.S. Application Data
(60) Provisional application No. 63/506,410, filed on Jun. 6, 2023.

(51) Int. Cl. B01J 27/185; B01J 21/18; B01J 35/45; B01J 37/02; B01J 37/04; B01J 37/08; C07B 37/02; C07F 5/02; C25B 11/054; C25B 11/061

(52) U.S. Cl. CPC B01J 27/1856; B01J 21/18; B01J 35/45; B01J 37/0203; B01J 37/0213; B01J 37/04; B01J 37/088; C07B 37/02; C07F 5/025; C25B 11/054; C25B 11/061

(57) ABSTRACT

Synthesis of metallic glass nanoparticles and compositions thereof, including, particularly, the kinetically controlled synthesis of glass nanoparticles by flash carbothermic reactions and compositions thereof.

### CROSS-REFERENCED TO RELATED PATENT APPLICATIONS

The application claims priority to U.S. Patent Appl. Ser. No. 63/506,410, to James M. Tour, et al., entitled “Synthesis Of Metallic Glass Nanoparticles By Flash Carbothermic Reactions And Compositions Thereof,” filed Jun. 6, 2023, which patent application is commonly owned by the owner of the present invention and is incorporated herein in its entirety.

### GOVERNMENT INTEREST

This invention was made with government support under Grant No. FA9550-19-1-0296 and No. FA9550-22-1-0526, awarded by the United States Air Force Office of Scientific Research. The United States government has certain rights in the invention.

### TECHNICAL FIELD

The present invention relates to the synthesis of metallic glass nanoparticles and compositions thereof, including, particularly, the kinetically controlled synthesis of glass nanoparticles by flash carbothermic reactions and compositions thereof.

### BACKGROUND

Nanoscale metallic glasses offer opportunities for investigating fundamental properties of amorphous solids [Yang 2021] and technological applications in biomedicine, microengineering, and catalysis [Kumar 2009; Glasscott 2019; Gao 2022]. The top-down fabrication of metallic glass nanostructure is restricted by the availability of bulk metallic glass [Chen 2011; Yan 2020]; in contrast, the bottom-up synthesis remains rarely explored due to the rigorous formation conditions, especially the extreme cooling rate [Zhong 2014].

Metallic glasses (MG), first discovered by melt quenching of the Au—Si alloy [Klement 1960], are a broad class of solid metallic materials with amorphous atomic structures [Greer 2009]. Depending on the glass forming ability (GFA) that is quantitatively described by the critical cooling rate (R_{C}), MG exhibit many dimensional forms. For example, MG ribbons, typically <100 μm, are made by rapid quenching of alloy melts [Klement 1960], MG thin films are fabricated by physical vapor deposition [Li M 2019; Ding 2014], and bulk MG with very low R_{C} are afforded by casting [Chen 2011; Kui 1984].

Recently, MG nanostructures have received considerable interests due to their unique atomic structures [Yang 2021], intriguing size-dependent mechanics [Kiani 2020; Sha 2019; Jang 2010], and the potential application in unconventional areas including additive manufacturing [Shen 2017], nanoimprinting [Kumar 2009], and catalysis [Glasscott 2019; Gao 2022; Li J 2019; Hu 2016; Carmo 2011; Pang 2021]. The present top-down fabrication of MG nanostructures involves thermoplastic forming [Kumar 2009; Carmo 2011; Kumar 2011], thermal drawing techniques [Yan 2020], selective etching [Wada 2007], and laser ablation [Liang 2021]. However, the top-down approaches rely on bulk MG counterpart availability, which heavily restricts the materials and composition choice.

However, the top-down approaches rely on bulk MG counterpart availability, which restricts the material and composition choice. The bottom-up nanoscale MG synthesis such as chemical reduction [Kiani 2020; Ma 2015; Zhao 2014; Wang 2021], electrochemical synthesis [Glasscott 2019; Zeeshan 2016], and physical vapor deposition [Liu 2015] affords better size, morphology, and compositional tunability. However, wet chemistry-based processes often lead to contaminated by surfactants [Wang 2021], while physical deposition methods require a substrate that hinders intrinsic property studies and wide-range applications.

It is highly desired but still very challenging to develop a bottom-up method for synthesis of nanoscale MG with pure and tunable compositions, small size, and good morphology.

### SUMMARY OF THE INVENTION

The present invention relates to the synthesis of metallic glass nanoparticles and compositions thereof, including, particularly, the kinetically controlled synthesis of glassy nanoparticles by flash carbothermic reactions (FCR) and compositions thereof.

In general, in one embodiment, the invention features a method for synthesizing metallic glass nanoparticles. The method includes mixing a metal/metalloid precursor with a material comprising carbon. The method further includes performing a flash Joule heating process using the material mixed with the metal/metalloid precursor in which the metal/metalloid precursors are decomposed and fused into alloy melts. The method further includes rapidly cooling the alloy melts to vitrify the alloy melts into the metallic glass nanoparticles.

Implementations of the invention can include one or more of the following features:

The method can include a kinetically controlled synthesis of the metallic glass nanoparticles.

The step of mixing can include dissolving the metal/metalloid precursor in a solvent to form a solution and wetting the material comprising the carbon with the solution.

A phosphorous source can be dissolved in the solvent when forming the solution.

The phosphorous source can be PPh₃.

The step of wetting can include impregnating the metal/metalloid precursor on the material comprising the carbon.

The solvent can be selected from the group consisting of alcohols, water, and mixtures thereof.

The solvent can include ethanol.

The carbon in the material can serve as a conductive additive and a supporting substrate in the flash Joule heating process.

The material can include carbon black.

The metallic glass nanoparticles can be Pd- and/or Pt-based metallic glass nanoparticles.

The metallic glass nanoparticles can be selected from the group consisting of PdNiP, PdCuP, PdCuNiP, PtNiP, PtCuP, PtCuNiP, and PdCuFeNiP metallic glass nanoparticles and combinations thereof.

The metallic glass nanoparticles can have the chemical formula M₁—M₂—P. M₁ can be selected from the group consisting of Pt, Pd, and combinations thereof. M₂ can be selected from the group consisting of Cu, Ni, Fe. Co, Sn, and combinations thereof.

The flash Joule heating process can include providing millisecond current pulses through the metal/metalloid precursor at a heating rate of at least 10² K/s.

The heating rate can be at least 10⁴ K/s.

The flash Joule heating process can raise the temperature of the metal/metalloid precursors to at least 1800 K.

The rapidly cooling can be performed at an ultrafast rate of cooling of at least 10² K/s.

The ultrafast rate of cooling be at least 10³ K/s.

The ultrafast rate of cooling can be by thermal radiation.

The metal/metalloid precursors can be selected from the group consisting of H₂PtCl₆, PdCl₂, CuCl₂, NiCl₂, FeCl₃, PPh₃, P₂O₅, and combinations thereof.

The metal/metalloid precursor can include a metal salt.

The metal salt can be selected from the group consisting of H₂PtCl₆, PdCl₂, CuCl₂, NiCl₂, FeCl₃, and combinations thereof.

In general, in another embodiment, the invention features a composition including metallic glass nanoparticles made by any of the above-described methods.

In general, in another embodiment, the invention features a method that includes using any of the above-described compositions a catalyst. The catalyst includes the metallic glass nanoparticles.

Implementations of the invention can include one or more of the following features:

The metallic glass nanoparticles can be used as catalysts for a hydrogen evolution reaction.

The metallic glass nanoparticles can be used as catalysts for clean H₂ production via water electrolysis.

The metallic glass nanoparticles can be used as catalysts for catalytic coupling.

The catalytic coupling can be of a boronic acid and an aryl halide.

The catalytic coupling can be Suzuki-Miyaura coupling or Miyaura-Heck coupling.

The metallic glass nanoparticles can include PtNiP metallic glass nanoparticles.

The metallic glass nanoparticles can include PdNiP metallic glass nanoparticles.

The metallic glass nanoparticles can be used as catalysts for a reaction selected from the group consisting of electrochemical reactions, hydrogen evolution reactions, oxygen reduction reactions, carbon dioxide reduction reactions, reactions used in fuel cells, carbon-carbon bond forming reactions, carbon hydrogen bond forming reactions, hydroformylation reactions, carbon monoxide insertion reactions, and reductive elimination reactions.

The metallic glass nanoparticles can be used as catalysts for a hydrogenation reaction.

The hydrogenation reaction can be hydrogenation of one or more alkenes and/or alkynes. The metallic glass nanoparticles can include a metal selected from the group consisting of Pd, Pt, Ni, and Rh.

The hydrogenation reaction can be hydrogenation of one or more nitriles. The metallic glass nanoparticles can include a metal selected from the group consisting of Pd, Pt, Ni, and Rh.

The hydrogenation reaction can be hydrogenation one or more aromatic compounds. The metallic glass nanoparticles can include a metal selected from the group consisting of Pd, Pt, and Ru.

The metallic glass nanoparticles can be used as catalysts for an oxidation reaction.

The oxidation reaction can be oxidation of one or more alcohols. The metallic glass nanoparticles can include a metal selected from the group consisting of Pd, Pt, and Ru.

The oxidation reaction can be oxidation of one or more olefins. The metallic glass nanoparticles can include a metal selected from the group consisting of Pd, Mn, and Co.

The oxidation reaction can be oxidation of one or more hydrocarbons. The metallic glass nanoparticles can include a metal selected from the group consisting of V and Mo.

The metallic glass nanoparticles can be used as catalysts for a carbon-carbon bond forming reaction.

The carbon-carbon bond forming reaction can be a Heck reaction. The metallic glass nanoparticles can include Pd.

The carbon-carbon bond forming reaction can be a Suzuki coupling. The metallic glass nanoparticles can include Pd.

The carbon-carbon bond forming reaction can be a Sonogashira coupling. The metallic glass nanoparticles can include a metal selected from the group consisting of Pd and Cu.

The carbon-carbon bond forming reaction can be a Stille coupling. The metallic glass nanoparticles can include Pd.

The carbon-carbon bond forming reaction can be a Negishi coupling: The metallic glass nanoparticles can include a metal selected from the group consisting of Pd and Ni.

The metallic glass nanoparticles can be used as catalysts for a polymerization reaction.

The polymerization can be a Ziegler-Natta polymerization. The metallic glass nanoparticles can include a metal selected from the group consisting of Ti and Al.

The polymerization can be a Metallocene polymerization. The metallic glass nanoparticles can include a metal selected from the group consisting of Zr and Ti.

The metallic glass nanoparticles can be used as catalysts for a reduction reaction.

The reduction reaction can be a Birch reduction. The metallic glass nanoparticles can include (a) Na and/or Li and (b) Fe.

The reduction reaction can be a catalytic transfer hydrogenation. The metallic glass nanoparticles can include a metal selected from the group consisting of Pd and Pt.

The metallic glass nanoparticles can be used as catalysts for a cross-coupling reaction.

The cross-coupling reaction can be a Buchwald-Hartwig amination. The metallic glass nanoparticles can include Pd.

The cross-coupling reaction can be a Kumada coupling. The metallic glass nanoparticles can include a metal selected from the group consisting of Ni and Pd.

The metallic glass nanoparticles can be used as catalysts for a metathesis reaction.

The metathesis reaction can be an olefin metathesis. The metallic glass nanoparticles can include a metal selected from the group consisting of Ru and Mo.

The metathesis reaction can be an alkyne metathesis. The metallic glass nanoparticles can include a metal selected from the group consisting of W and Mo.

The metallic glass nanoparticles can be used as catalysts for a C—H activation.

The C—H activation can be a C—H functionalization. The metallic glass nanoparticles can include a metal selected from the group consisting of Pd, Rh, and Ru.

The metallic glass nanoparticles can be used as catalysts for a water-gas shift reaction: Iron (Fe) and copper (Cu) catalysts.

The metallic glass nanoparticles can be used as catalysts for a Fischer-Tropsch synthesis. The metallic glass nanoparticles can include a metal selected from the group consisting of Fe and Co.

The metallic glass nanoparticles can be used as catalysts for an ammonia synthesis (Haber Process). The metallic glass nanoparticles can include Fe.

The metallic glass nanoparticles can be used as catalysts for a methanol synthesis. The metallic glass nanoparticles can include a metal selected from the group consisting of Cu and Zn.

The metallic glass nanoparticles can be used as catalysts for a Wacker process. The metallic glass nanoparticles can include a metal selected from the group consisting of Pd and Cu.

### BRIEF DESCRIPTION OF THE DRAWINGS

FIGS. 1A-1E show synthesis of MGNP by flash carbothermic reaction. FIG. 1A is a schematic of the FCR process for MGNP synthesis. FIG. 1B shows molecular dynamics simulated atomic model of a ternary MGNP. FIG. 1C is a pulsed current curve under the FCR conditions of 100 V and 50 ms. Inset of FIG. 1C are pictures of the sample before (top) and during (bottom) the FCR reaction (scale bar, 1 cm). FIG. 1D is a real-time temperature curve recording using an infrared thermometer. Tₘₐₓ and T_{g} are the maximum temperature of the FCR process and the glass transition temperature of PdNiP, respectively. FIG. 1E is a schematic of the time-temperature transformation diagram showing the kinetic formation of MG. Tₘ and T_{g} are the melting temperature and the glass transition temperature of PdNiP, respectively.

FIGS. 2A-2I show characterization of PdNiP MCNP. FIG. 2A is a XRD pattern of the PdNiP MGNP supported on carbon black. The PDF reference card is graphite (PDF #41-1487). FIG. 2B is a bright-field transmission electron microscopy (BF-TEM) image of the PdNiP MGNP supported on carbon black. Inset of FIG. 2B is SAED pattern of the MGNP supported on carbon black. The scale bar is 50 nm for the TEM image, and 5 nm⁻¹ for the SAED pattern. FIG. 2C is a HRTEM image of the PdNiP MGNP and corresponding FFT image (inset of FIG. 2C). Scale bar, 5 nm. FIG. 2D is a nanobeam diffraction pattern of the PdNiP MGNP, and the intensity profile derived from the electron diffraction. k₁ and k₂ are the first and second diffraction vectors, respectively. Scale bar, 5 nm⁻¹. FIG. 2E shows size distribution of the PdNiP MGNP. The average size is 10.6±1.6 nm. FIG. 2F shows elemental composition of the PdNiP MGNP determined by EDS. Three points were collected with the average composition of Pd₄₃Ni₂₆P₃₁. FIG. 2G is XPS fine spectrum of Pd. FIG. 2H is XPS fine spectrum of Ni. FIG. 2I is XPS fine spectrum of P.

FIGS. 3A-3F show general synthesis of MGNP by the FCR process with HRTEM images, corresponding FFT patterns, HAADF-STEM images, elemental maps, and EDS spectra for (a) FIG. 3A: ternary PdNiP MGNP; (b) FIG. 3B: ternary PdCuP MGNP; (c) FIG. 3C: ternary PtCuP MGNP; (d) FIG. 3D: quaternary PdCuNiP MGNP; (e) FIG. 3E: quaternary PtCuNiP MGNP; and (f) FIG. 3F: quinary, high-entropy PtPdCuNiP MGNP. All scale bars in the HRTEM images and STEM images are 10 nm.

FIGS. 4A-4N show nanoscale effect enhanced glass forming ability. FIG. 4A is the phase diagram of the ternary Pd—Ni—P system. The compositions of bulk MG and ribbon MG were from literatures values. [He 1996; Schluckebier 1983]. FIG. 4B is calculated R_{C} of the ternary Pd—Ni—P system. The dash line denotes the composition of P=20 at %. FIG. 4C shows molecular dynamics simulated 3D atomic model of MG nanoparticle with composition of Pd₁₂₆Ni₁₂₇P₆₀ (P at %˜19%). FIG. 4D shows molecular dynamics simulated 3D atomic model of MG bulk with composition of Pd₁₇₀Ni₁₇₀P₈₀ (P at %˜19%). FIGS. 4E-4F are local bond orientational order parameters of all the atoms in, respectively, (E) the MG nanoparticle and (F) the MG bulk. The dashed curves denote the normalized bond orientational order parameter at 0.5, which serves as the criterion differentiating disordered and ordered structures. FIG. 4G shows the ten most abundant Ni/Pd-centered Voronoi polyhedra in the MG nanoparticle. FIG. 4H shows four representative Ni/Pd-centered Voronoi polyhedra. FIG. 4I shows the ten most abundant P-centered Voronoi polyhedra in the MG nanoparticle. FIG. 4J shows four representative P-centered Voronoi polyhedra. FIG. 4K is the coordination number distribution of Ni/Pd and P for MG nanoparticle. The average coordination number of Ni/Pd and P are 11.5 and 7.9, respectively. FIG. 4L is the coordination number distribution of Ni/Pd and P for MG bulk. The average coordination number of Ni/Pd and P are 11.1 and 8.8, respectively.

FIGS. 5A-5H show nanoscale effect enhanced glass forming ability. FIG. 5A shows calculated R_{C} of the ternary Pd—Co—P system. The black line denotes R_{C}=10⁴ K s⁻¹. FIG. 5B shows a HRTEM image of PdCoP MGNP. Scale bars, 10 nm. The inset of FIG. 5B shows the corresponding FFT pattern. FIG. 5C shows EDS spectrum of PdCoP MGNP. FIG. 5D shows calculated R_{C} of the ternary Pd—Sn—P system. The black line denotes R_{C}=10⁴ K s⁻¹. 5E shows a HRTEM image of PdSnP MGNP. Scale bars, 10 nm. The inset of FIG. 5E shows the corresponding FFT pattern. FIG. 5F shows EDS spectrum of PdSnP MGNP. FIG. 5G shows a HRTEM image, the corresponding FFT pattern, HAADF-STEM image, and EDS maps of PdCuFeNiP MGNP. Scale bars, 10 nm. FIG. 5H shows EDS spectrum of PdCuFeNiP MGNP.

FIG. 6 shows TABLE III, which is a table reflecting the chemical state analysis of MGNP by XPS.

FIG. 7 shows TABLE V, which is a table reflecting some PdNiP catalyzed Suzuki-Muyara reactions.

FIG. 8 shows TABLE VI, which is a table reflecting some PdNiP MGNP catalyzed Miyaura-Heck reactions.

FIG. 9 shows TABLE VIII, which is a table reflecting some recently reported previous metal-based HER electrocatalytsts in acid solution, as well as the use of ternary PtNiP MGNP as the high-performance electrocatalyst.

### DETAILED DESCRIPTION

The present invention relates to the synthesis of metallic glass nanoparticles and compositions thereof, including, particularly, the kinetically controlled synthesis of glass nanoparticles by flash carbothermic reactions and compositions thereof.

A kinetically controlled flash carbothermic reaction featuring ultrafast heating (>10⁵ K s⁻¹) and cooling (>10⁴ K s⁻¹) has been discovered for the synthesis of metallic glass nanoparticles (MGNP) within milliseconds. Various permutations of noble metals, base metals, and metalloid (M₁—M₂—P, M₁=Pt/Pd, M₂=Cu/Ni/Fe/Co/Sn) have been synthesized with widely tunable particle sizes and supportive substrates. Through combinatorial development, a substantially larger phase space of nanoscale metallic glass has been discovered compared to the bulk counterpart, revealing that the nanosize effect enhanced glass forming ability. Guided by this, several nanoscale metallic glasses with elemental compositions have been synthesized that have never, to Applicant's knowledge, been synthesized in bulk. The metallic glass nanoparticles show high activity in heterogeneous catalysis, outperforming crystalline metal alloy nanoparticles.

A thermal process for nanoscale MG synthesis necessitates certain features. First, a high temperature is necessary to ensure the intimate mixing of multiple metal elements with diverse miscibility, as MGs are typically composed of three or more elements. [Greer 2009]. Second, a short reaction duration is required to minimize particle agglomeration and achieve uniform, nanoscale particle dispersion. Finally, an ultrafast cooling rate is needed to vitrify the alloy melt and avoid crystallization. Recently, several unconventional thermal processes [Chen 2016; Liu 2022; Deng 2021] have been reported for synthesizing alloy nanoparticles with single-phase crystal structures, such as the electrothermal-based shock synthesis of high-entropy alloy nanoparticle [Yao 2018; Yao 2020; Cui 2022; Yao 2022], the photothermal-based laser ablation synthesis of high-entropy alloy and ceramic nanoparticles [Wang 2022], and the flash Joule heating synthesis of metastable nanocrystals [Chen 2021; Deng I 2022; Deng II 2022]. It is believed that by rational composition design, nonequilibrium thermal processes can kinetically suppress crystallization and produce metastable glassy materials.

The present invention relates to the flash carbothermic reaction (FCR) for the general synthesis of metallic glass nanoparticles (MGNP). Metal precursors loaded on a carbon substrate are subjected to millisecond current pulses, rapidly raising the temperature to ˜1800 K through Joule heating (>10⁵ K s⁻¹). The resulting ally melts then cool at an ultrafast rate (>10⁴ K s⁻¹) through thermal radiation, vitrifying into glassy nanoparticles. FCR is feasible for the synthesis of various Pd- and Pt-based MGNP, including palladium-nickel-phosphorous (PdNiP), PdCuP, PdCuNiP, PtNiP, PtCuP, PtCuNiP, and the high-entropy PtPdCuNiP.

By constructing the phase diagram of PdNiP nanoparticles through combinational development, it was discovered that the composition space of MG at the nanoscale is substantially expanded than that of the bulk counterpart, showing that the nanosize effect enhances the GFA. Structural simulations further revealed delicate short-range order differences between nanoscale and bulk MG. The enhanced GFA allows for the synthesis of nanoscale MG with compositions that have never been achieved in bulk, exemplified by PdCoP, PdSnP, and high-entropy PdCuFeNiP. Furthermore, applications of MGNP in heterogenous catalysis have been performed, which outperform the crystalline counterparts.

### Synthesis of PdNiP MGNP by Flash Carbothermic Reaction

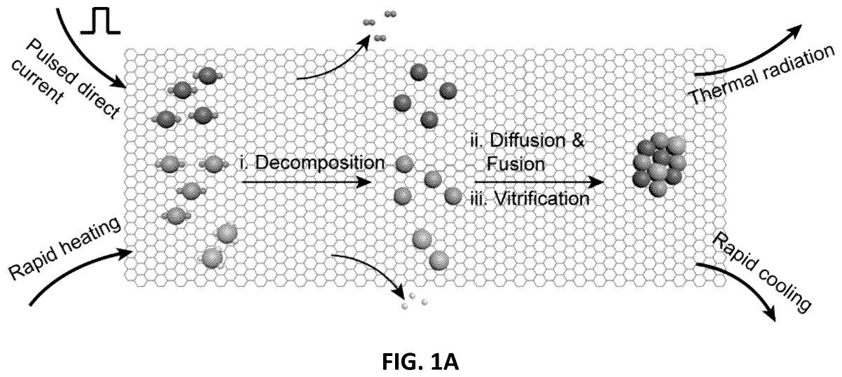

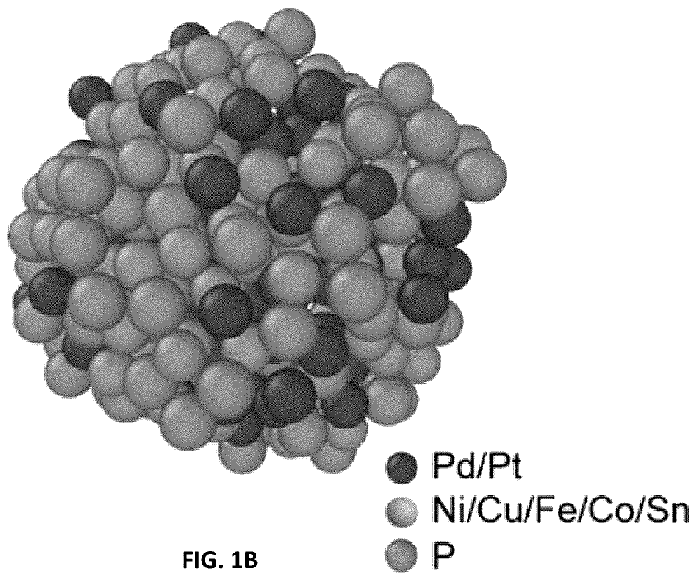

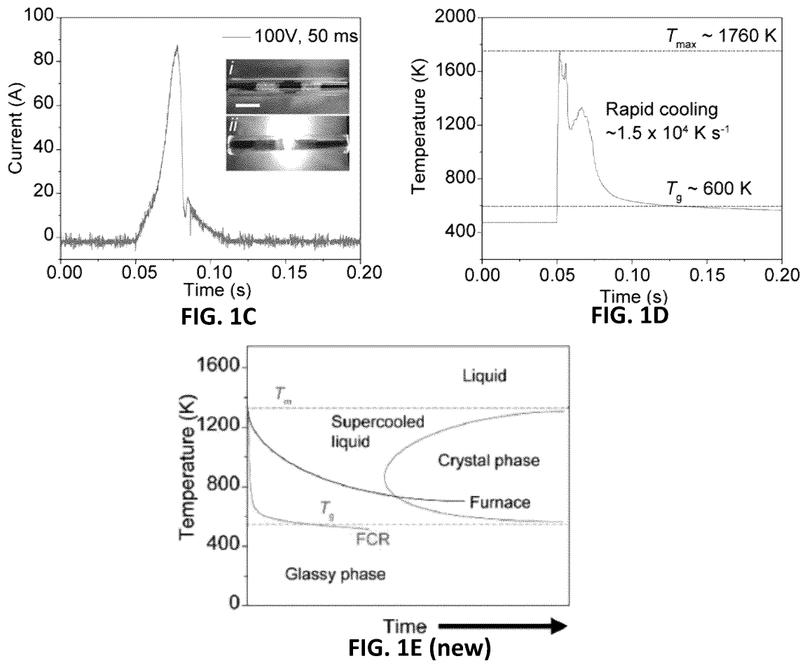

In embodiments, the flash carbothermic reaction (FCR) for MGNP synthesis involves three steps (FIG. 1A):

First, the metal/metalloid precursors are dissolved (such as in ethanol) and homogeneously wet impregnated onto a support (such as a carbon black support), which simultaneously served as the conductive additive and supporting substrate. (Structurally, the carbon black is composed of amorphous carbon nanospheres.)

Then, pulsed direct current input rapidly ramps up the sample to a high temperature [Yao 2018; Johnson 2011], leading to the decomposition of the metal precursors and elemental liquid metals. See FIG. 1A. Since these metals do not wet carbon, the liquid metals diffuse to reduce their surface energy at high temperature, and subsequently fuse into alloy melts driven by the negative enthalpy of mixing (ΔHₘᵢₓ). [Takeuchi 2001].

The sample was then rapidly cooled due to the intensive thermal radiation and low heat capacity of carbon substrate (<0.033 J K⁻¹) [Butland 1973] (FIG. 1A), resulting in the vitrification of the alloy melt into glassy nanoparticles (FIG. 1B).

Due to the good GFA of ternary palladium-nickel-phosphorous (PdNiP), it was chosen and synthesized as a representative example [Chen 2011]. In a typical trial, a pulsed current of ˜90 A within 50 ms was applied to the precursor mixture in an Ar-filled chamber (FIG. 1C). With strong light emission (FIG. 1C, inset), the sample temperature rapidly reached its maximum at Tₘₐₓ˜1760 K (FIG. 1D) beyond the decomposition temperature of metal precursors. See TABLE I.

TABLE I
Physical properties of the metal precursors
and corresponding metals/metalloids

| | Decomposition | Metal/ | Melting | Boiling |
|---|---|---|---|---|
| Precursors | temp. (K) | Metalloid | point (K) | point (K) |
| PdCl₂ | 863-1013 | Pd | 1828 | 3236 |
| H₂PtCl₆ | >783 | Pt | 2041 | 4098 |
| CuCl₂ | 1273 | Cu | 1358 | 3200 |
| NiCl₂ | 1073 | Ni | 1728 | 3186 |
| FeCl₃ | >773 | Fe | 1811 | 3134 |
| PPh₃ | Crack^{a} | P | 860 | 893 (sublimation) |

Note:
^{a}The thermal homolysis temperature of organics is usually well below 1270K. In the FCR process, the maximum temperature is ~1760K, which is enough for the decomposition of PPh₃.

Based on Tₘₐₓ and the glass transition temperature (T_{g}) of PdNiP (˜600 K) [Chen 1973], the cooling rate was calculated to be ˜1.5×10⁴ K s⁻¹, which is higher than the R_{C} of PdNiP bulk MG [He 1996].

Deviating from thermodynamically equilibrium crystal phases, metallic glass is typically trapped by a kinetic barrier. According to the temperature-time transformation diagram, as schematically shown in FIG. 1E, the cooling rate determines the formation of glassy or crystal phases. In the scenario of FCR, the rapid cooling enables the glassy phase formation. As a control, the synthesis using a tube furnace with a slow cooling rate (˜10 K min⁻¹) led to the formation of crystalline PdNiP nanoparticles.

### Characterization of PdNiP MGNP

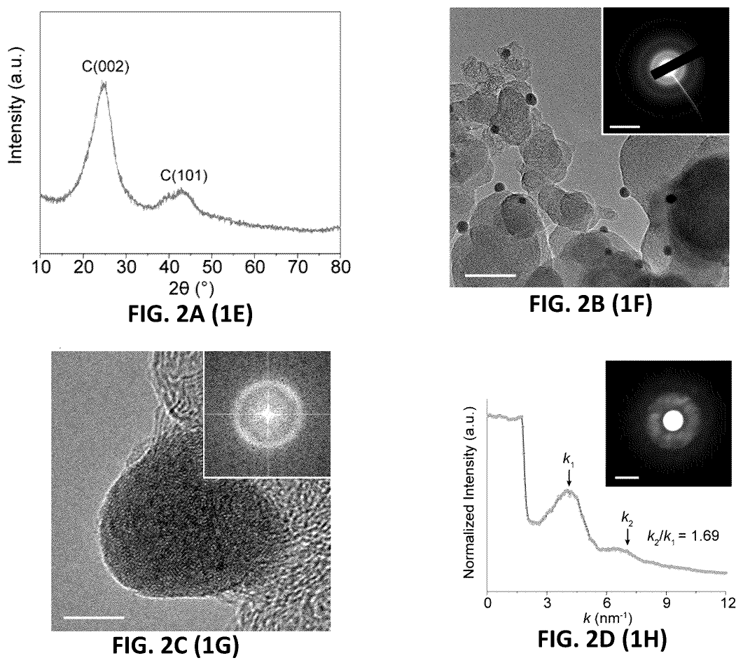

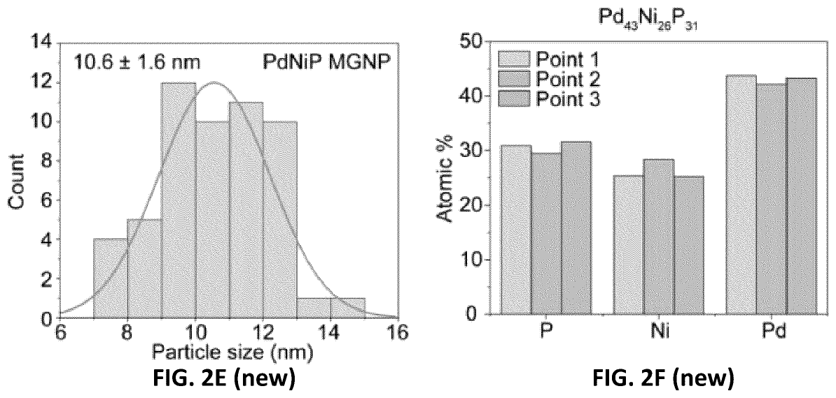

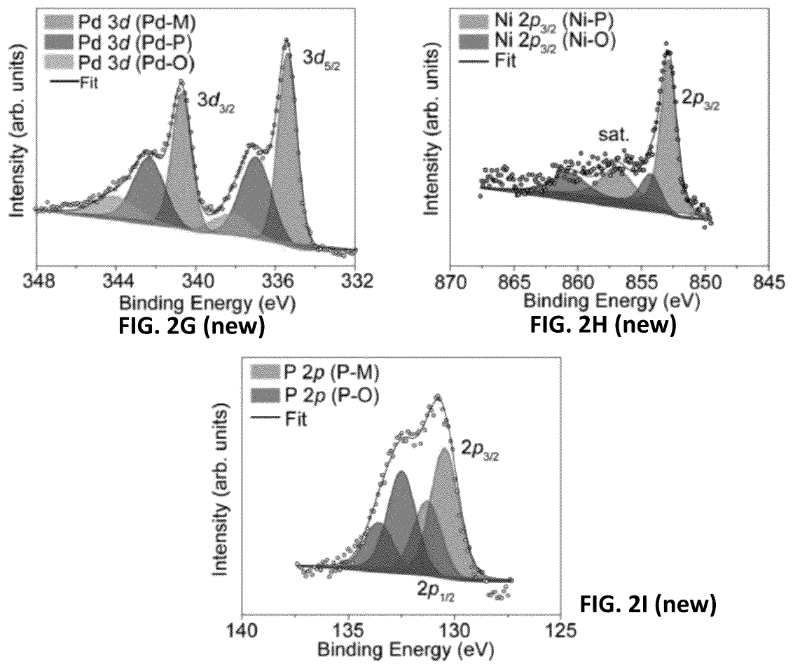

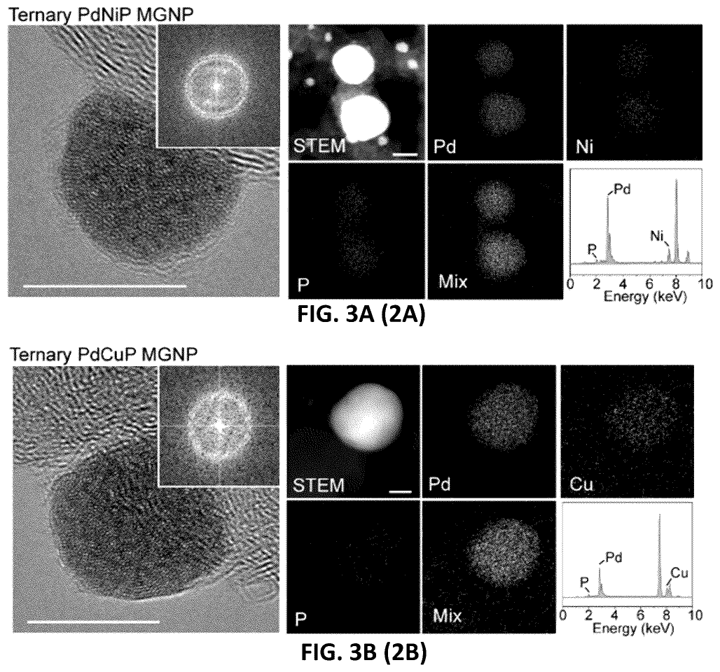

The amorphous structure of the as-obtained PdNiP NP was confirmed by X-ray diffraction (XRD) and transmission electron microscopy (TEM). The XRD pattern did not show any peaks from crystalline components, except for the broad diffraction peaks from the amorphous carbon support (FIG. 2A). The synthesized nanoparticles (NPs) were supported on the carbon black (FIG. 2B). The selected-area electron diffraction (SAED) showed diffusive diffraction halos without discrete spot (FIG. 2B, inset).

The amorphous structure was further confirmed by high-resolution TEM (HRTEM) and the corresponding fast Fourier transformation (FFT) pattern (FIG. 2C). HRTEM images with tilt range from 0° to 5° were acquired, and all are characterized of an amorphous structure.

To exclude the effect of the carbon support, nanobeam diffraction was performed on a single NP that showed similar diffuse halos (FIG. 2D, inset). The normalized intensity of the nanobeam diffraction pattern showed the main peak positions at 4.12 nm⁻¹ and 6.96 nm⁻¹, which corresponds to k₂/k₁˜1.69 (FIG. 2D), in agreement with previous experimental results on PdNiP bulk MG [Lan 2017].

The particle size was calculated based on the data from the TEM images, showing an average size of ˜10.6 nm and a narrow size distribution (FIG. 2E). The average composition was determined to be Pd₄₃Ni₂₆P₃₁ by energy-dispersive X-ray spectroscopy (EDS) (FIG. 2F).

The element composition of the MGNP were determined by statistics using EDS. Taking PdNiP MGNP as an example, the EDS spectrum shows the appearance of Pd, Ni, P, and C peaks. The C peak is from the carbon support. Three points were tested and obtained the elemental ratios of Pd (43.1±0.8 at %), Ni (26.3±1.8 at %), and P (30.7±1.0 at %), so the composition of the MGNP could be estimated as Pd43Ni26P31. The small standard deviation showed the compositional uniformity of the MGNP. Based on the same method, TABLE II shows the elemental compositions of particular MGNP.

TABLE II
Elemental composition of MGNP

| MGNP | Average composition |
|---|---|
| PdNiP MGNP | Pd₄₃Ni₁₂₆P₃₁ |
| PdCuP MGNP | Pd₄₈Cu₃₀P₂₂ |
| PdCuNP MGNP | Pd₄₉Cu₁₃N₁₈P₃₀ |
| PtNiP MGNP | Pt₃₄Ni₄₄P₂₂ |
| PtCuP MGNP | Pt₃₄Cu₃₈P₂₈ |
| PtCuNiP MGNP | Pt₄₈Cu₁₄Ni₁₁P₂₇ |
| PtPdCuNiP MGNP | Pt₂₁Pd₃₂Cu₁₁Ni₁₉P₂₇ |
| PdCoP MGNP | Pd₃₉Co₂₂P₃₉ |
| PdSnP MGNP | Pd₂₆Sn₁₈P₅₆ |
| PdCuNiFeP MGNP | Pd₃₃Cu₁₇Ni₁₅Fe₁₇P₂₁ |

Due to the short duration of the FCR process and the temperatures being ≤2500 K, the carbon substrates remain unchanged. The high temperature of the FCR process resulted in the complete reaction, leaving no chloride residue in the product.

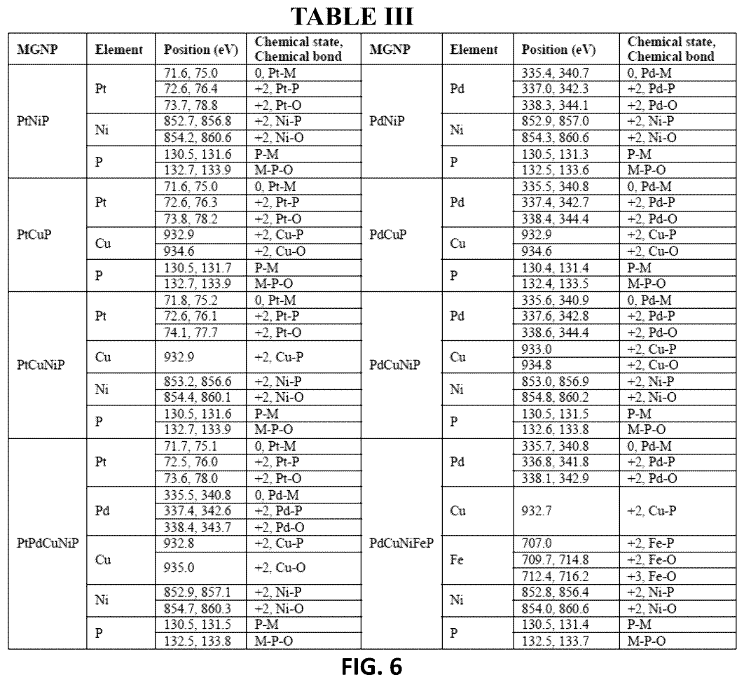

The electronic structures of the PdNiP MGNP were investigated by X-ray photoemission spectroscopy (XPS). (See FIGS. 2G-2I; FIG. 6 (showing TABLE III)).

Various chemical bonds, including Pd—Pd, Ni—Ni, P—P, Pd—Ni, Pd—P and Ni—P, were found, resulting from its amorphous feature. The Pd 3d is split into two peaks of Pd 3d_{5/2} and 3d_{3/2} (FIG. 2G). The Pd 3d_{5/2} peak at 335.4 eV is assigned to Pd—M (including Pd—Pd [Kohiki 1990] and Pd—Ni [Hillebrecht 1982]). The Pd 3d_{5/2} peak at 337.0 eV is assigned to Pd—P. [Nefedov 1980]. The minor Pd 3d_{5/2} peak at 338.3 eV could be assigned to be Pd—O [Kim 1974] due to the surface oxidation. The Ni 2p_{3/2} peak at 852.9 eV is assigned to Ni—P, and the peak at 857.0 eV is its satellite peak [Jin 2020] (FIG. 2H). The minor Ni 2p_{3/2} peak at 854.3 eV can be assigned to Ni—O due to surface oxidation. The P 2p is split into two peaks of P 2p_{3/2} and 2p_{1/2}. For P 2p_{3/2}, the peak at 130.5 eV is assigned to P—M [Wang 1988], and the peak at 132.5 eV could be assigned to M—P (FIG. 2I).

### General Synthesis of Pd- and Pt-Based Metallic Glass Nanoparticles

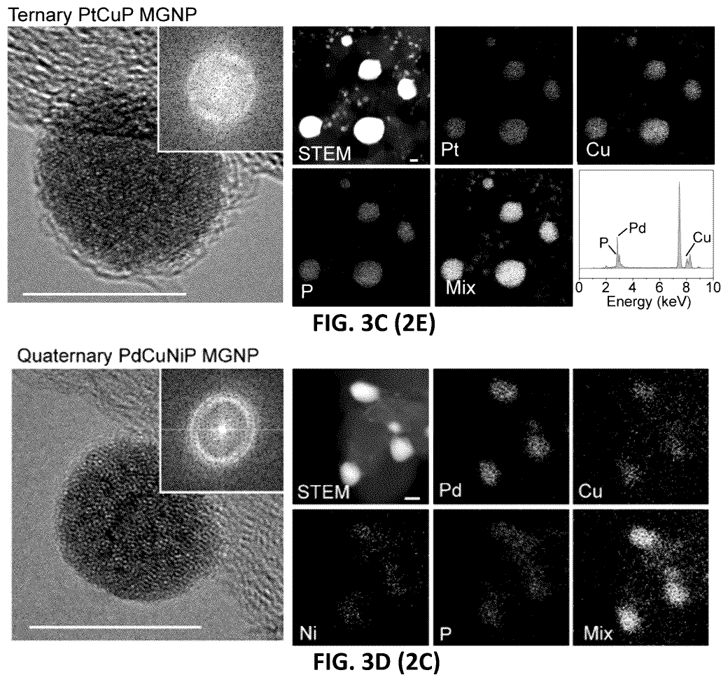

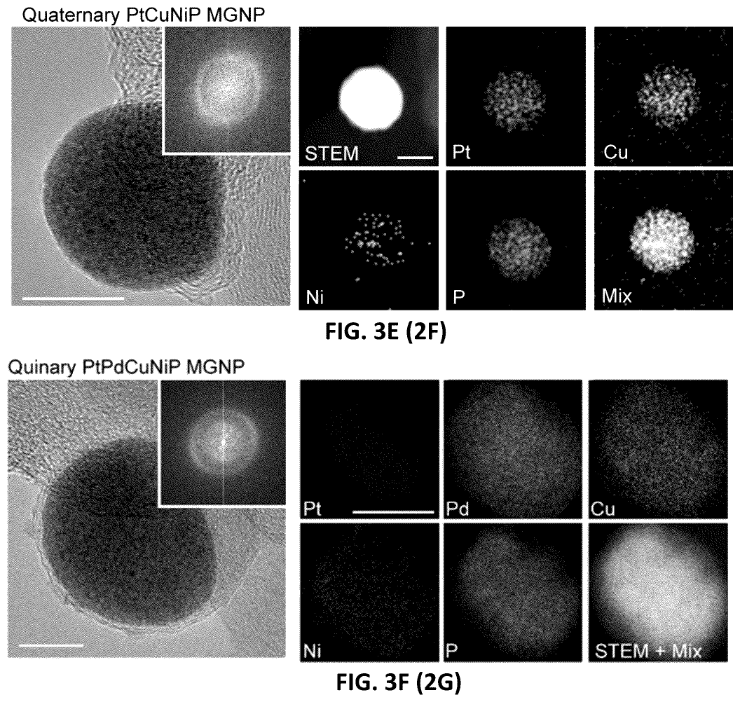

To demonstrate the versatility of the FCR method utilized in embodiments of the present invention, a series of Pd- and Pt-based MGNP were synthesized using different precursors (FIGS. 3A-3F; FIG. 6 (TABLE III); and TABLE IV).

TABLE IV
Precursors and FCR conditions for MGNP synthesis

| | Mass | FCR | FCR | | |
|---|---|---|---|---|---|
| Precursor Molar Ratios | loading | voltage | time | | Product |
| Pd:Ni:P = 1:1:2 | 5 wt % | 100 V | 50 | ms | PdNiP MGNP |
| Pd:Cu:P = 1:1:2 | 5 wt % | 100 V | 50 | ms | PdCuP MGNP |
| Pd:Cu:Ni:P = 1:1:1:2 | 5 wt % | 100 V | 50 | ms | PdCuNiP MGNP |
| Pt:Ni:P = 1:1:2 | 5 wt % | 100 V | 50 | ms | PtNiP MGNP |
| Pt:Cu:P = 1:1:2 | 5 wt % | 100 V | 50 | ms | PtCuP MGNP |
| Pt:Cu:Ni:P = 1:1:1:2 | 5 wt % | 100 V | 50 | ms | PtCuNiP MGNP |
| Pt:Pd:Cu:Ni:P = 1:1:1:1:2 | 5 wt % | 100 V | 50 | ms | PtPdCuNiP MGNP |
| Pd:Co:P = 1:1:2 | 5 wt % | 100 V | 50 | ms | PdCoP MGNP |
| Pd:Sn:P = 1:1:2 | 5 wt % | 100 V | 50 | ms | PdSnP MGNP |
| Pd:Cu:Fe:Ni:P = 1:1:1:1:2 | 5 wt % | 100 V | 50 | ms | PdCuFeNiP MGNP |
| Pt | 5 wt % | 100 V | 50 | ms | Pt crystal NP |
| Pt:Ni | 5 wt % | 100 V | 50 | ms | PtNi crystal NP |
| Pt:Ni:P = 1:1:2 | 5 wt % | 100 V | 100 | ms | crystal NP |
| Pd:Ni:P = 1:1:2 | 5 wt % | 100 V | 150 | ms | crystal NP |
| Pt:Ni:P = 1:1:2 | 5 wt % | 100 V | 100 | ms | Crystal NP |

Note:
The precursors are PdCl₂, NiCl₂, CuCl₂, H₂PtCl₆, FeCl₂, and PPh₃. The mass loading denotes the mass ratio of Pd or Pt with respect to carbon black.

Generally, the GFA of an alloy was susceptible to its composition, where the difference of a few atomic ratio percentages could induce a change of R_{C} by several orders of magnitude [Bordeenithikasem 2017]. Nevertheless, due to the presence of deep eutectics in the Pd—P and Pt—P systems, the Pd- and Pt-based MG can be synthesized over a wide compositional range [Schwartz 1997]. To control product composition, an excessive supply of P was employed given its high volatility compared to other metal components. (See TABLE I and TABLE IV).

The amorphous features of the as-synthesized nanoparticles were confirmed through multiscale characterization methods including XRD, SAED, and HRTEM. The average compositions were Pd₄₃Ni₂₆P₃₁ (FIG. 3A), Pd₄₈Cu₃₀P₂₂ (FIG. 3B), Pt₃₄Cu₃₈P₂₈ (FIG. 3C), Pd₄₉Cu₁₃Ni₈P₃₀ (FIG. 3D), Pt₄₈Cu₁₄Ni₁₁P₂₇ (FIG. 3E), and the quinary Pt₂₁Pd₃₂Cu₁₁Ni₉P₂₇ (FIG. 3F) which is considered as high-entropy MG [Glasscott 2019; Takeuchi 2011; Duan 2022]. High-angle annular dark-field scanning transmission electron microscopy (HAADF-STEM) image and element maps demonstrated uniform distributions of elements. The nanoparticles exhibited structural and elemental uniformity, regardless of their compositions. The EDS spectra of individual nanoparticles of all compositions show the absence of carbon or oxygen peaks (FIGS. 3A-3F), proving that the as-synthesized nanoparticle is metallic glass, instead of oxide glass or carbide phase. The carbon black served as the conductive additive and substrate and did not participate in the reaction.

The FCR method for MGNP synthesis provides wide tunability in terms of the particle size, dispersity, compositions, and the substrates. The MGNP showed a narrow size distribution with coefficient of variation <10%. The particle size can be tuned by varying precursor loadings from 5 to 100 nm is tunable, such as by changing precursor loading or the FCR time durations; but particle size generally cannot be adjusted independently from loading. The synthesized MGNP were uniformly dispersed on the carbon black support, and other conductive carbons like carbon nanotubes can be used, expanding the range of substrate applicability.

The MPNPs remained stable in atmospheric conditions and preserve their structure, size, and morphology even after six months of storage.

The FCR process for MGNP synthesis also demonstrated good scalability. By simply increasing the FCR voltage, a 0.2 g per batch was achieved. Considering the time used to charge the FCR system and the loading of the sample, we conclude that the time required for the 200 mg batch synthesis is ˜10 s, corresponding to a production rate of 72 g h⁻¹, higher than other reported methods like chemical reduction, electrochemical synthesis, and physical vapor deposition.

### Nanosize Effect Enhanced Glass Forming Ability

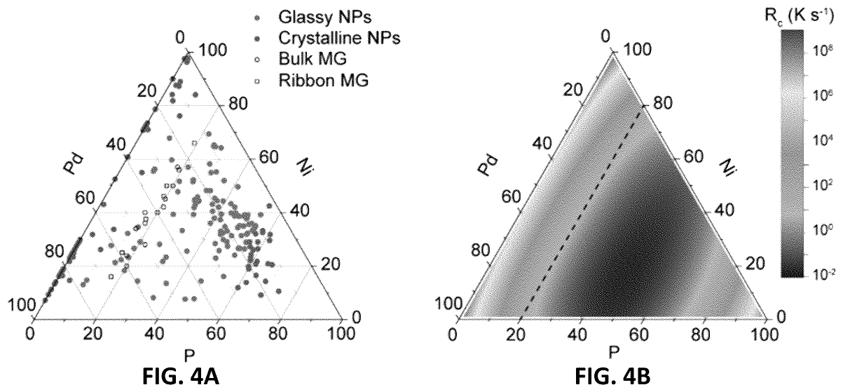

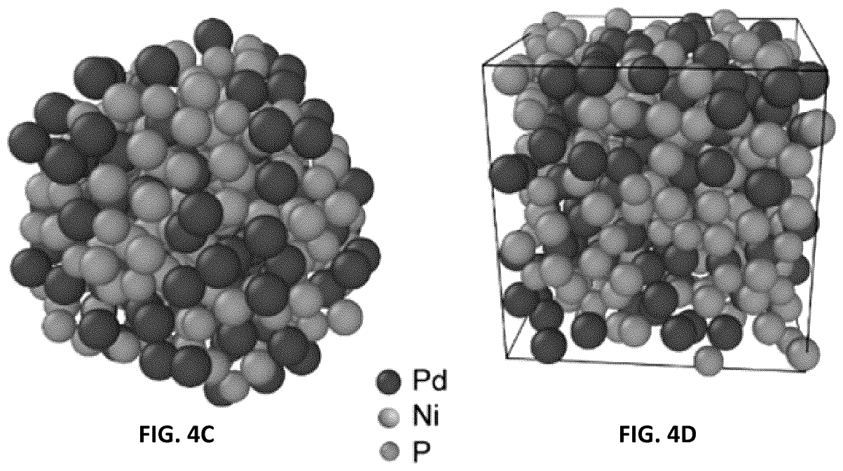

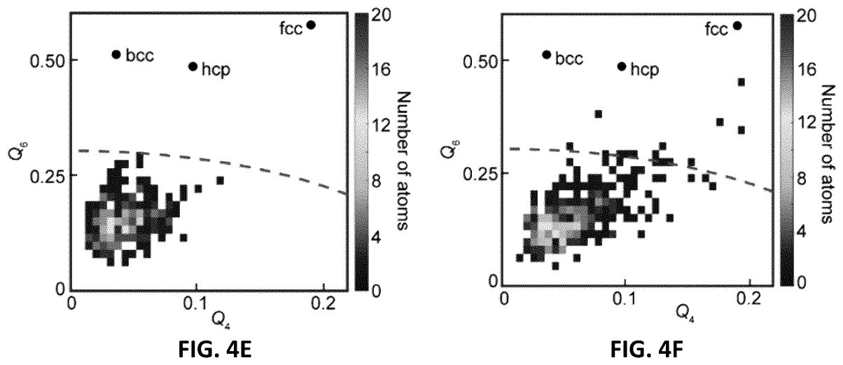

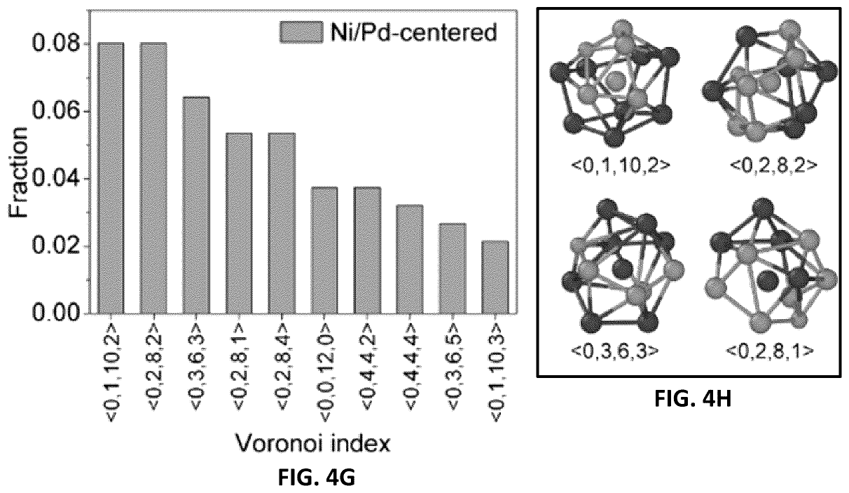

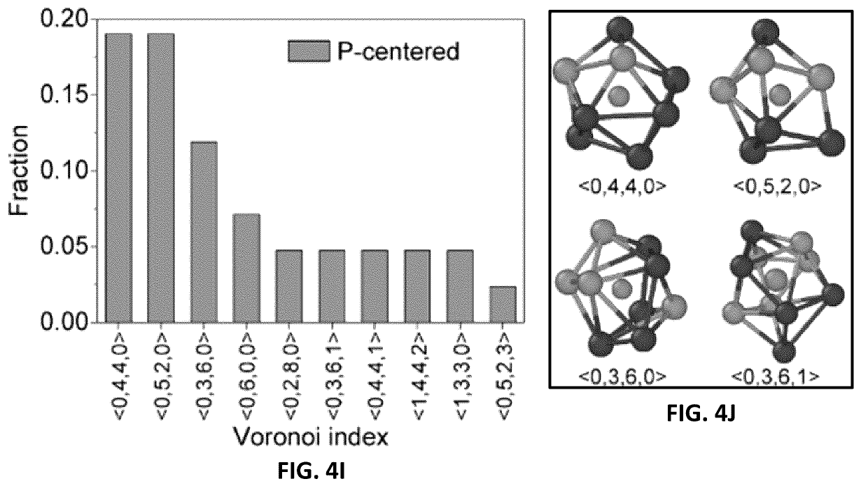

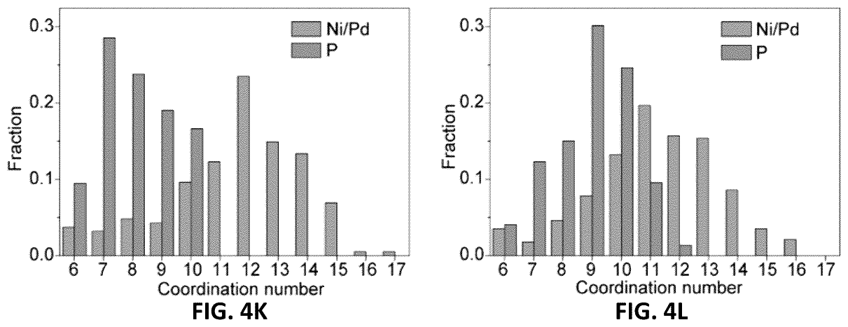

Combining easily tunable precursor loading and ultrafast synthesis, the FCR provides access to a broad compositional space of MG. Exemplified by the ternary Pd—Ni—P alloy, a large library of PdNiP nanoparticles were synthesized by combinatorial development. Their phases (crystalline or glassy) and compositions were determined by TEM and EDS, respectively (FIG. 4A). The ternary Pd—Ni—P phase diagram revealed that ˜54% of the nanoparticles formed a glassy phase, covering about 10 to 55 at % of P. As a comparison, the compositions of ribbon MG [Schluckebier 1983] and bulk MG [He 1996] appear to lie close to P ˜20 at % (FIG. 4A), which is rooted in the deep eutectic points at approximately Ni₈₀P₂₀ and Pd₈₀P₂₀. Therefore, the composition space of PdNiP MG at the nanoscale is substantially larger than the bulk counterpart, i.e., the nanosize effect can enhance the glass forming ability.

The R_{C} determines whether the phase is crystalline or glassy under a specific cooling rate. The composition-dependent R_{C} was calculated using an empirical model [Takeuchi 2001] and a recently developed algorithm [Gabski 2020]. (FIG. 4B). The R_{C} strongly correlate to the P content, with compositions of 20 to 70 at % of P having R_{C}<100 K s⁻¹ (FIG. 4B). For P content <10 at % or >80 at %, R_{C} surges to >10⁴ K s⁻¹. As the cooling rate of the present FCR is in the order of 10⁴ K s⁻¹ (FIG. 1D), it affords the synthesis of PdNiP MGNP with P content down to ˜10 at % (FIG. 4B). This is consistent with experimental results, where crystalline phases form at P <10 at % (FIG. 4A).

To further explain the dimension dependent GFA, ab initio molecular dynamics was implemented to explore the MG structure in both the nanoparticulate and bulk forms. A PdNiP nanoparticle surrounded by a vacuum layer (FIG. 4C) and a PdNiP supercell under periodic boundary conditions (FIG. 4D), with the same composition ratio (Pd:Ni:P˜2:2:1) were modeled. While both ensembles had amorphous atomic structures, the local bond orientational order was employed to quantitatively describe the degree of disorder. [Yang 2021; Lechner 2008].

100% atoms in the MG nanoparticle are disordered under the normalized bond orientational order parameters criterion (FIG. 4E). By contrast, while most atoms (˜96.4%) in the MG bulk are disordered, some have crystal features approaching hexagonal close packed (hcp) or face cubic center (fcc) structures (FIG. 4F). These results demonstrated that, even with the same composition, the MG nanoparticle was more disordered than its bulk counterpart, echoing the experimental observation that the nanosize effect enhanced GFA.

A series of MG with P content of ˜11, ˜19, ˜33, ˜40, and ˜52 at % were modeled, where all nanoparticles are more disordered than the bulk counterparts, regardless of the composition.

Furthermore, the subtle differences in short-range order between nanoscale and bulk MG were analyzed based on Voronoi tessellation [Yang 2021; Guan 2012; Sheng 2006]. In metal-metalloid MG, the metals (Ni, Pd) and metalloid (P) have distinct local orders [Guan 2012]. The ten most abundant Ni/Pd-centered Voronoi polyhedra of MG nanoparticle are shown in FIG. 4G. Common motifs observed in MG, such as distorted icosahedra with indices of <0, 1, 10, 2>, <0, 2, 8, 2> and <0, 2, 8, 1>, and <0, 3, 6, 3> are identified (FIG. 4H). For the P-centered cases (FIG. 4I), frequently encountered polyhedra include tricapped trigonal prisms with index of <0, 3, 6, 0>, and distorted tricapped trigonal prisms with index of <0, 4, 4, 0>, <0, 5, 2, 0>, and <0, 3, 6, 1> (FIG. 4J).

The Voronoi polyhedra of the MG bulk are mostly the same with those in the nanoparticle. The polyhedral face distribution of all the Voronoi polyhedra showed the most abundant 5-edged Ni/Pd-centered faces in both MG nanoparticle and bulk. By contrast, the 4-edged P-centered polyhedral faces were the most abundant for MG nanoparticle and 5-edged ones for MG bulk. Moreover, the coordination numbers of all the atoms in the MG were determined based on the Voronoi index, from Σᵢnᵢ (FIGS. 4K-4L). The average first-neighbor coordination numbers of Ni/Pd in MG nanoparticle (˜11.5) was very similar with that of MG bulk (˜11.1). However, the average coordination numbers of P in MG nanoparticle (7.9) are smaller than that of MG bulk at 8.8, clearly revealing the more disordered local structure of MG in nanoparticle form.

### Synthesis of MGNP with Expanded Composition Space

The conclusion of nanosize effect enhanced GFA has at least two implications. First, for a given alloy system, a composition ratio that cannot form bulk MG may form glassy material at the nanoscale. The strict composition requirement for bulk MG formation would be lessened for bottom-up nanoscale MG synthesis, as demonstrated by the synthesis of Pd—Ni—P MGNP with wide tunable composition. FIG. 4A.

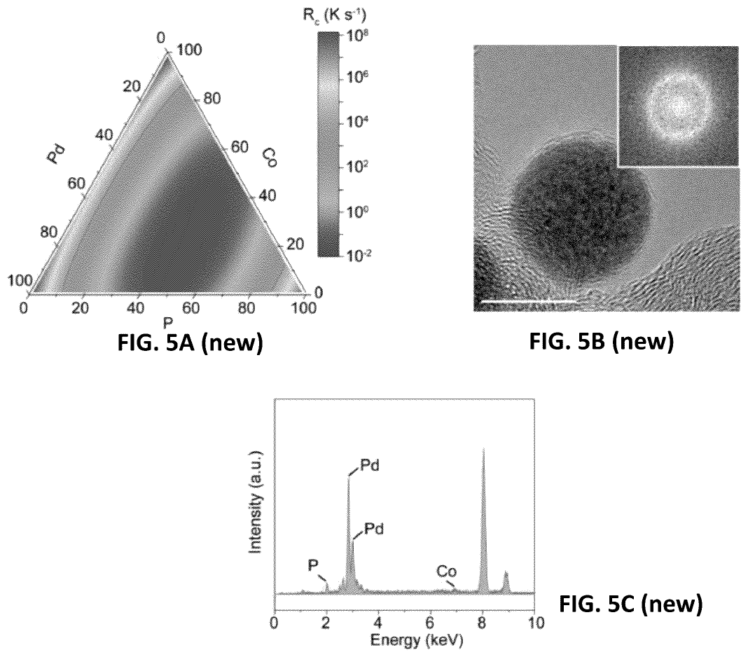

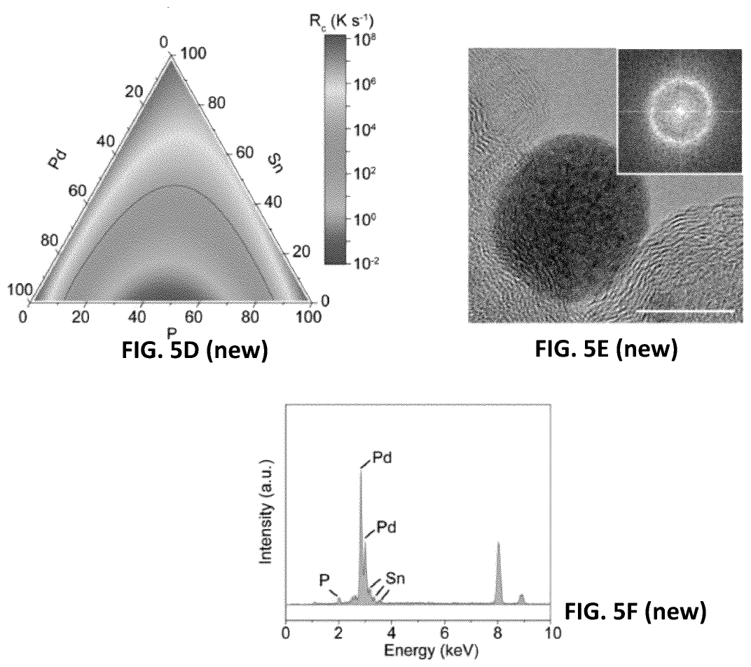

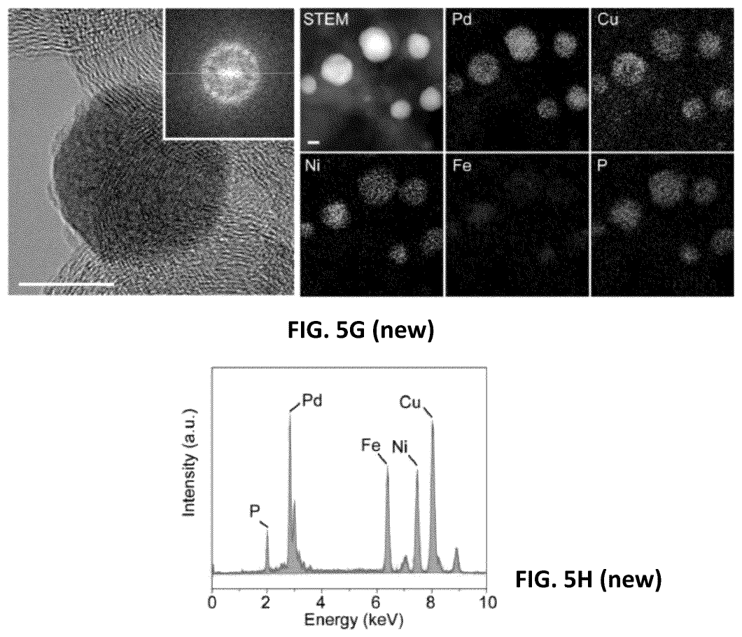

Second, an alloy system that is inaccessible for bulk MG may form MG at the nanoscale. Based on this, the composition space of Pd-based MG was expanded. Combined with the composition-dependent R_{C} calculation, the MGNP synthesis could be rationally designed. As examples, the choice of base metals was expanded and the synthesis of PdCoP (FIGS. 5A-5C) and PdSnP MGNPs (FIGS. 5D-5F) were achieved. Due to the similar property of Co and Ni, the composition-dependent R_{C} for Pd—Co—P system (FIG. 5A) resembles to that of Pd—Ni—P (FIG. 4B), where P content can be critical. By contrast, the calculated R_{C} of Pd—Sn—P (FIG. 5D) showed that all three elements can be critical for the glassy formation. Furthermore, Fe was incorporated and the high-entropy PdCuNiFeP MGNP (FIGS. 5G-5H) was synthesized. To Applicant's knowledge, these MGNP compositions have not yet been reported in bulk form, so it is unknown whether they can be synthesized in bulk. The present invention thus provides a process for a wide range of glassy materials and high entropy materials.

### Catalytic Applications of the Metallic Glass Nanoparticles

Due to the versatility of the FCR method, the synthesized MGNP can find wide applications in various fields. I.e., the FCR enables the scalable and rapid production of uniformly dispersed MGNP with diverse elemental compositions, which are promising in wide-range applications.

As a representative example, the application of MGNP in heterogeneous catalysis, exemplified by Suzuki-Miyaura coupling of a boronic acid and an aryl halide has been shown.

### PdNiP MGNP Catalyzed Suzuki-Miyaura Coupling Reactions

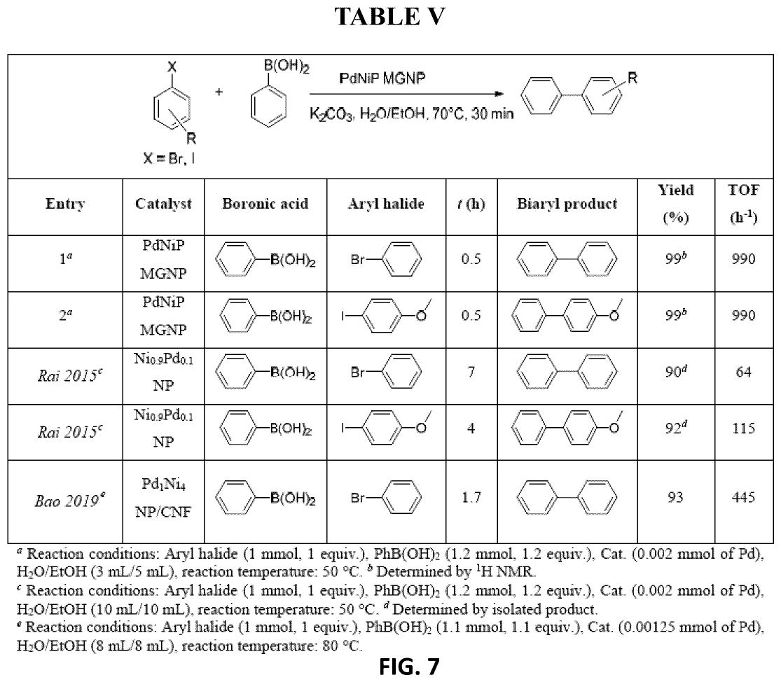

As shown in FIG. 7 (TABLE V), the PdNiP MGNP was used for catalyzing the Suzuki-Miyaura reaction. Experimentally, a reaction flask was charged with freshly prepared catalyst (5 mg of the as-prepared PdNiP/carbon black with Pd at ˜5 wt %, corresponding to 0.2 mol % of Pd), water/ethanol (v/v=3 mL/5 mL), the aryl boronic acid (1.2 mmol), K₂CO₃ (2.0 mmol), and the aryl halide (1.0 mmol). The mixture was stirred and heated at 70° C. for 30 min. The reaction progress was monitored by thin layer chromatography (TLC). After complete reaction, the product was analyzed by nuclear magnetic resonance (NMR). The yield, turnover number (TON), and turnover frequency (TOF) were calculated by: Yield=n(product, mol)/n(precursor, mol), TON=n(product, mol)/n(Pd, mol), and TOF=TON/t, where t is the reaction time in h.

The results were shown in FIG. 7 (TABLE V). High yields (>99%) for different coupled biaryl products were obtained with the PdNiP MGNP catalyst under mild reaction conditions. These results were compared with literature reports of bimetallic catalysts of Ni_{0.9}Pd_{0.1} nanoparticles [Rai 2015], and Pd₁Ni₄/CNF [Bao 2019]. (FIG. 7 (TABLE V)). The yields from the PdNiP MGNP were higher than those of the bimetallic PdNi catalysts. To assess the intrinsic catalytic performance of these Pd-based catalysts, the TOF was calculated. The TOF of the PdNiP MGNP was significantly higher than the bimetallic Ni_{0.9}Pd_{0.1} and Pd₁Ni₄, demonstrating the high intrinsic activity of the PdNiP MGNP. This could be due to the optimized electronic structure by the synergic Pd—Ni—P interactions, as well as the geometric effect through which the amorphous structure has more actives sites for catalysis.

### PdNiP MGNP Catalyzed Miyaura-Heck Coupling Reaction

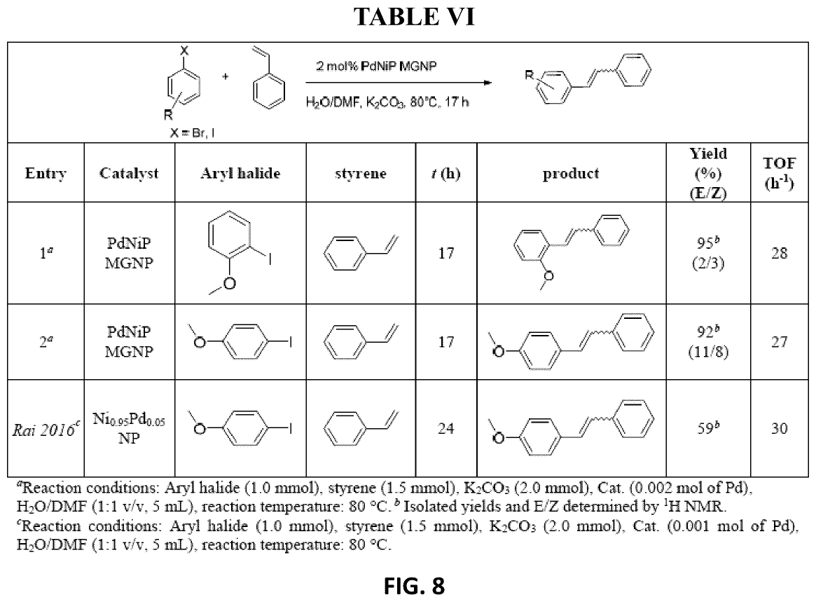

As shown in FIG. 8 (TABLE VI), the PdNiP MGNP was used for catalyzing the Miyaura-Heck reaction. The catalyst (5 mg of the as-prepared PdNiP/carbon black with Pd of ˜5 wt %, corresponding to 0.2 mol % of Pd based on aryl Iodide) in DMF (2.5 mL) and DI water (2.5 mL) was sonicated for 5 min. K₂CO₃ (2 mmol), aryl iodide (1.0 mmol), and styrene (1.5 mmol) were added. After 17 h, the product was purified by silica gel chromatography and analyzed by ¹H NMR. The yield, turnover number (TON), and turnover frequency (TOF) were calculated by:

$$Yield = n ( product , mol ) / n ( precursor , mol ) ;$$

$$TON = n ( product , mol ) / n ( Pd , mol ) ; and$$

$$TOF = TON / t ,$$

where t is the reaction time in h.

The results were shown in FIG. 8 (TABLE VI). High yields (>92%) for different coupled products were obtained with the PdNiP MGNP catalyst under mild reaction conditions.

These results were compared with the bimetallic Ni_{0.95}Pd_{0.05} nanoparticle reported in literature [Rai 2016]. FIG. 8 (TABLE VI). The yields catalyzed by the PdNiP MGNP are higher than that by the bimetallic PdNi catalyst, and a comparable TOF is obtained.

### Results

Again, in this representative example, the application of MGNP in heterogeneous catalysis has been shown, exemplified by Suzuki-Miyaura coupling of a boronic acid and an aryl halide. TABLE VII shows the Pt content in various catalysts.

TABLE VII
Pt content in various catalysts

| Materials | PtNiP MGNP/CB | PtNi NP/CB | Pt/C |
|---|---|---|---|
| Pt wt % | 5.88 | 6.84 | 17.2 |

High yields (>99%) for different coupled biaryl products were obtained with the PdNiP MGNP catalyst under mild reaction conditions. The yields were higher than those of the bimetallic PdNi catalyst nanoparticles. [Yan 2019]. To assess the intrinsic catalytic performance of these Pd-based catalysts, the turnover frequency (TOF) was calculated. The TOF of the PdNiP MGNP is significantly higher than the bimetallic Ni_{0.9}Pd_{0.1} and Pd₁Ni₄, demonstrating the high intrinsic activity of the PdNiP MGNP. This could be due to the optimized electronic structure by the synergic Pd—Ni—P inter-actions, as well as the geometric effect through which the amorphous structure has more active sites for catalysis. In addition, the Pd—Ni—P MGNP also exhibited high yields for catalytic coupling of aryl halides and styrene by Miyaura-Heck coupling. FIG. 8 (TABLE VI).

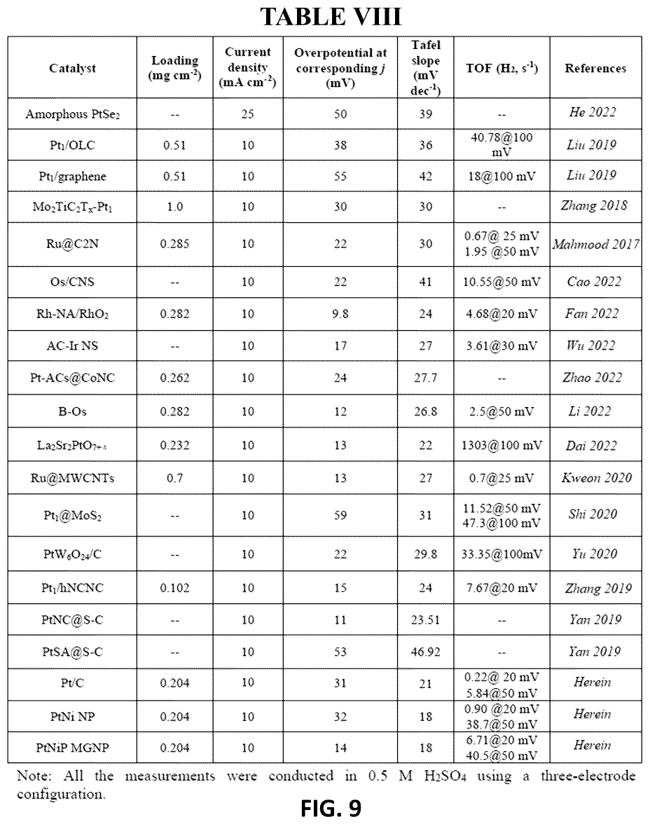

Other representative examples of use as a catalyst includes use of the ternary PtNiP MGNP as a high-performance electrocatalyst for the hydrogen evolution reaction (HER). FIG. 9 (TABLE VIII (showing some recently reported previous metals-based HER electrocatalysts in acid solution, as well as the use of ternary PtNiP MGNP as the high-performance electrocatalyst).

Again, due to the versatility of the FCR method, the synthesized MGNP provide wide applications in various fields.

The methods and systems of the present invention are also related to PCT Patent Appl. Serial Nos. PCT/US21/52030, PCT/US21/52043, PCT/US21/52057, and PCT/US21/52070, to James M. Tour et al., each entitled “Ultrafast Flash Joule Heating Synthesis Methods And Systems For Performing Same,” each filed Sep. 24, 2021, and each claiming priority to U.S. Patent Appl. Ser. No. 63/082,592, filed Sep. 24, 2020. These applications are incorporated herein in their entirety.

While embodiments of the invention have been shown and described, modifications thereof can be made by one skilled in the art without departing from the spirit and teachings of the invention. The embodiments described and the examples provided herein are exemplary only, and are not intended to be limiting. Many variations and modifications of the invention disclosed herein are possible and are within the scope of the invention. The scope of protection is not limited by the description set out above, but is only limited by the claims which follow, that scope including all equivalents of the subject matter of the claims.

The disclosures of all patents, patent applications, and publications cited herein are hereby incorporated herein by reference in their entirety, to the extent that they provide exemplary, procedural, or other details supplementary to those set forth herein.

Amounts and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of approximately 1 to approximately 4.5 should be interpreted to include not only the explicitly recited limits of 1 to approximately 4.5, but also to include individual numerals such as 2, 3, 4, and sub-ranges such as 1 to 3, 2 to 4, etc. The same principle applies to ranges reciting only one numerical value, such as “less than approximately 4.5,” which should be interpreted to include all of the above-recited values and ranges. Further, such an interpretation should apply regardless of the breadth of the range or the characteristic being described.

Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are now described.

Following long-standing patent law convention, the terms “a” and “an” mean “one or more” when used in this application, including the claims.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in this specification and attached claims are approximations that can vary depending upon the desired properties sought to be obtained by the presently disclosed subject matter.

As used herein, the term “about” and “substantially” when referring to a value or to an amount of mass, weight, time, volume, concentration or percentage is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed method.

As used herein, the term “substantially perpendicular” and “substantially parallel” is meant to encompass variations of in some embodiments within ±10° of the perpendicular and parallel directions, respectively, in some embodiments within ±5° of the perpendicular and parallel directions, respectively, in some embodiments within ±1° of the perpendicular and parallel directions, respectively, and in some embodiments within ±0.5° of the perpendicular and parallel directions, respectively.

As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D.

### REFERENCES

Int'l PCT Patent Publ. No. WO 2021/076670, “Porous Polymeric Carbon Sorbents For CO₂ Capture And Methods of Making And Using Same,” filed Oct. 14, 2020, to Tour, J. T., et al. (“Tour '670 PCT Application”.)
Bao, G., et al., “Synergistic effect of the Pd—Ni bimetal/carbon nanofiber composite catalyst in Suzuki coupling reaction,” Org. Chem. Front., 2019, 6, 352-361 (“Bao 2019”).
Battezzati, L., et al., “The viscosity of liquid-metals and alloys,” Acta Metall., 1989, 37, 1791-1802 (“Batezzati 1989”).
Blochl, P. E., “Projector augmented-wave method,” Phys. Rev. B, 1994, 50, 17953-17979 (“Blochl 1994”).
Bordeenithikasem, P., et al., “Determination of critical cooling rates in metallic glass forming alloy libraries through laser spike annealing,” Sci. Rep., 2017, 7, 7155 (“Bordeenithikasem 2017”).
Butland, A. T. D. et al., “The specific heat of graphite: An evaluation of measurements,” J. Nucl. Mater., 1973, 49, 45-56 (“Butland 1973”).
Cao, D., et al., “Volcano-type relationship between oxidation states and catalytic activity of single-atom catalysts towards hydrogen evolution,” Nat. Commun., 2022, 13, 5843 (“Cao 2022”).
Capece, F. M, et al., “Copper chromite” Catalysts: XPS structure elucidation and correlation with catalytic activity,” J. Electron Spectros. Relat. Phenomena, 1982, 27, 119-128 (“Capece 1982”).
Carmo, M., et al., “Bulk metallic glass nanowire architecture for electrochemical applications,” ACS Nano, 2011, 5, 2979-2983 (“Carmo 2011”).
Chen, H. S., “Glass temperature, formation and stability of Fe, Co, Ni, Pd and Pt based glasses,” Mater. Sci. Eng., 1976, 23, 151-154 (“Chen 1976”).
Chen, H. S., “Composition dependence of the glass transition temperatures of Pd—Ni—P and Pt—Ni—P glasses,” J. Non Cryst. Solids, 1973, 12, 333-338 (“Chen 1973”).
Chen, M., “A brief overview of bulk metallic glasses,” NPG Asia Mater., 2011, 3, 82-90 (“Chen 2011”).
Chen, W., et al., “Millisecond Conversion of Metastable 2D Materials by Flash Joule Heating,” ACS Nano., 2021, 15(1), 1282-1290 (“Chen 2021”).
Chen, Y., et al., “Ultra-fast self-assembly and stabilization of reactive nanoparticles in reduced graphene oxide films,” Nat Commun., 2016, 7, 12332 (“Chen 2016”).
Cui, M., et al., “Multi-principal elemental intermetallic nanoparticles synthesized via a disorder-to-order transition,” Sci. Adv., 2022, 8, eabm4322 (“Cui 2022”).
Dai, J., et al., “Hydrogen spillover in complex oxide multifunctional sites improves acidic hydrogen evolution electrocatalysis,” Nat. Commun., 2022, 13, 1189 (“Dai 2022”).
Debski, A., et al., “New features of entall database: comparison of experimental and model formation enthalpies,” Arch. Metall. Mater., 2014, 59, 1337-1343 (“Debski 2014”).
Deng, B., et al., “Phase controlled synthesis of transition metal carbide nanocrystals by ultrafast flash Joule heating,” Nat. Commun., 2022, 13, 262 (“Deng I 2022”).
Deng, B., et al., “High-surface-area corundum nanoparticles by resistive hotspot-induced phase transformation,” Nat. Commun., 2022, 13, 5027 (“Deng I 2022”).
Ding, S. Y., et al., “Combinatorial development of bulk metallic glasses.” Nat. Mater., 2014, 13, 494-500 (“Ding 2014”).
Duan, Y. J., et al., “Analysis of the anelastic deformation of high-entropy Pd₂₀Pt₂₀Cu₂₀Ni₂₀P₂₀ metallic glass under stress relaxation and recovery,” Journal of Mater. Sci. Technol., 2022, 107, 82-91 (“Duan 2022”).
Dudarev, S. L., et al., “Electron-energy-loss spectra and the structural stability of nickel oxide: An LSDA+U study,” Phys. Rev. B, 1998, 57, 1505-1509 (“Dudarev 1998”).
Fan, Z., et al., “Coupling of nanocrystal hexagonal array and two-dimensional metastable substrate boosts H₂-production,” Nat. Commun., 2022, 13, 5828 (“Fan 2022”).
Gabski, M., et al., “Exploring the phase space of multi-principal-element alloys and predicting the formation of bulk metallic glasses,” Entropy, 2020, 22, 292 (“Gabski 2020”).
Gao, F.-Y., et al., “Nickel-molybdenum-niobium metallic glass for efficient hydrogen oxidation in hydroxide exchange membrane fuel cells,” Nat. Catal., 2022, 5, 993-1005 (“Gao 2022”).
Glasscott, M. W., et al., “Electrosynthesis of high-entropy metallic glass nanoparticles for designer, multi-functional electrocatalysis,” Nat. Commun., 2019, 10, 2650 (“Glasscott 2019”).
Green, C. L., et al., “Determination of the platinum and ruthenium surface areas in platinum-ruthenium alloy electrocatalysts by underpotential deposition of copper. I. Unsupported catalysts,” J. Phys. Chem. B, 2002, 106, 1036-1047 (“Green 2002”).
Greer, A. L., “Metallic glasses . . . on the threshold,” Mater. Today, 2009, 12, 14-22 (“Greer 2009”).
Guan, P. F., et al., “Structural origins of the excellent glass forming ability of Pd₄₀Ni₄₀P₂₀,” Phys. Rev. Lett., 2012, 108, 175501-175505 (“Guan 2012”).
He, Y., et al., “Amorphizing noble metal chalcogenide catalysts at the single-layer limit towards hydrogen production,” Nat. Catal., 2020, 5, 212-221 (“He 2022”).
He, Y., et al., “Synthesis and properties of bulk metallic glasses in Pd—Ni—P and Pd—Cu—P alloys,” MRS Proc., 1996, 455, 495-500 (“He 1996”).
Hillebrecht, F. U., et al., “Invalidity of 4f count determination and possibilities for determination of 4f hybridization in intermetallics of the light rare earths by core-level spectroscopy,” Phys Rev., 1982, 25, 3550 (“Hillebrecht 1982”).
Hines, A. L. et al., “Determination of the coordination-number of liquid-Mmtals near the melting-point,” Metall. Mater. Trans. A Phys. Metall. Mater Science, 1985, 16, 267-274 (“Hines 1985”).
Hu, Y. C. et al., “A highly efficient and self-stabilizing metallic-glass catalyst for electrochemical hydrogen generation,” Adv. Mater., 2016, 28, 10293-10297 (“Hu 2016”).
Jang, D., et al., “Transition from a strong-yet-brittle to a stronger-and-ductile state by size reduction of metallic glasses,” Nat. Mater., 2010, 9, 215-219 (“Jang 2010”).
Jin, Z. L., et al., “Efficient Photocatalytic Hydrogen Production Achieved by WO₃ Coupled with NiP₂ Over ZIF-8,” Catal. Surv. Asia, 2020, 24, 59-69 (“Jin 2020”).
Johnson, W. L., et al., “Beating crystallization in glass-forming metals by millisecond heating and processing,” Science, 2011, 332, 828-833 (“Johnson 2011”).
Kiani, M. T., et al., “Ductile metallic glass nanoparticles via colloidal synthesis,” Nano Lett., 2020, 20, 6481-6487 (“Kiani 2020”).
Kim, K. S., et al., “X-ray Photoelectron Spectroscopic Studies of Palladium Oxides and the Palladium-Oxygen Electrode,” Anal. Chem., 1974, 46, 197 (“Kim 1974”).
Kim, K. S., et al., “Electron spectroscopy of platinum-oxygen surfaces and application to electrochemical studies,” J. Am. Chem. Soc., 1971, 93, 6296-6297 (“Kim 1971”).
Kiminami, C. S., et al., Science and Technology of the Undercooled Melt: Rapid Solidification Materials and Technologies (eds Sahm, P. R., et al.) 246-248 (Springer Netherlands, 1986) (“Kiminami 1986”)
Klement, W., et al., “Non-crystalline structure in solidified gold-silicon alloys,” Nature, 1960, 187, 869-870 (“Klement 1960”).
Kohiki, S., et al., “Temperature-dependent change of Cu-O bond in La₂CuO₄ and YBa₂Cu₃O₇,” J. Mater. Sci., 1990, 25, 1344-1346 (“Kohiki 1990”).
Kresse, G., et al., “Efficient iterative schemes for ab initio total-energy calculations using a plane-wave basis set,” Phys. Rev. B, 1996, 54, 11169-11186 (“Kresse 1996”).
Kui, H. W., et al., “Formation of bulk metallic-glass by fluxing,” Appl. Phys. Lett., 1984, 45, 615-616 (“Kui 1984”).
Kumar, G., et al., “Bulk metallic glass: The smaller the better,” Adv. Mater., 2011, 23, 461-476 (“Kumar 2011”).
Kumar, G., et al., “Nanomoulding with amorphous metals,” Nature, 2009, 457, 868-872 (“Kumar 2009”).
Kweon, D. H., et al., “Ruthenium anchored on carbon nanotube electrocatalyst for hydrogen production with enhanced Faradaic efficiency,” Nat. Commun., 2020, 11, 1278 (“Kweon 2020”).
Lan, S. et al., “Hidden amorphous phase and reentrant supercooled liquid in Pd—Ni—P metallic glasses,” Nat. Commun., 2017, 8, 14679 (“Lan 2017”).
Lechner, W., et al., “Accurate determination of crystal structures based on averaged local bond order parameters,” J. Chem. Phys., 2008, 129, 114707 (“Lechner 2008”).
Li, J. Y., et al., “Recent advances in metallic glass nanostructures: Synthesis strategies and electrocatalytic applications,” Adv. Mater., 2019, 31, 1802120-1802147 (“Li J 2019”).
Li, M. X., et al., “High-temperature bulk metallic glasses developed by combinatorial methods,” Nature, 2019, 569, 99-103 (“Li M 2019”).
Li, Y., et al., “Interstitial boron-triggered electron-deficient Os aerogels for enhanced pH-universal hydrogen evolution,” Nat. Commun., 2022, 13, 1143 (“Li 2022”).
Liang, S.-X., et al., “A laser-based synthesis route for magnetic metallic glass nanoparticles,” Scr. Mater., 2021, 203, 114094-114099 (“Liang 2021”).
Liu, D., et al., “Atomically dispersed platinum supported on curved carbon supports for efficient electrocatalytic hydrogen evolution,” Nat. Energy, 2019, 4, 512-518 (“Liu 2019”).
Liu, S., et al., “Extreme Environmental Thermal Shock Induced Dislocation-Rich Pt Nanoparticles Boosting Hydrogen Evolution Reaction,” Adv. Mater., 2022, 34(2), 2106973 (“Liu 2022”).
Liu, Y. H., et al., “Metallic glass nanostructures of tunable shape and composition,” Nat. Commun., 2015, 6, 7043 (“Liu 2015”).
Luong, D. X., et al., “Gram-scale bottom-up flash graphene synthesis,” Nature, 2020, 577, 647-651 (“Luong 2020”).
Ma, Y. et al., “Amorphous PtNiP particle networks of different particle sizes for the electro-oxidation of hydrazine,” RSC Adv., 2015, 5, 68655-68661 (“Ma 2015”).
Mahmood, J. et al., “An efficient and pH-universal ruthenium-based catalyst for the hydrogen evolution reaction,” Nat. Nanotechnol., 2017, 12, 441-446 (“Mahmood 2017”).
Militello, M. C., et al., “Palladium chloride (PdCl₂) by XPS,” Surf. Sci. Spectra, 1994, 3, 402-409 (“Militello 1994”).
Monkhorst, H. J., et al., “Special points for Brillouin-zone integrations,” Phys. Rev. B, 1976, 13, 5188-5192 (“Monkhorst 1976”).
Nefedov, V. I., et al., “ESCA study of transition metal complexes of secondary phosphine chalcogenides: [M₂(PR₃)₂(μ-EPR′₂)₂],” Inorg. Chim. Acta, 1980, 45(3), L103-L104 (“Nefedov 1980”).
Nefedov, V. I. et al., “A study by XPS and XRS of the participation in chemical bonding of the 3d electrons of copper, zinc and gallium,” J. Electron Spectros. Relat. Phenomena, 1975, 6, 231-238 (“Nefedov 1975”).
Pang, Y., et al., “Self-supported amorphous nanoporous nickel-cobalt phosphide catalyst for hydrogen evolution reaction,” Prog. Nat. Sci.: Mater. Int., 2021, 31(2), 201-206.
Parmigiani, F., et al., “The Cu2p X-ray photoelectron core-lines in copper-oxide based high-temperature superconductors,” J. Electron Spectros. Relat. Phenomena, 1994, 66, 223-239 (“Parmigiani 1994”).
Perdew, J. P., et al. “Accurate and simple analytic representation of the electron-gas correlation energy,” Phy. Rev. B, 1992, 45, 13244-13249 (“Perdew 1992”).
Pope, T. D., et al., “Surface and interfacial alloys of Pd with Cu(100): structure, photoemission and CO chemisorption,” Surf. Sci., 1994, 306, 294-312 (“Pope 1994”).
Rai, R. K., et al., “Access to highly active Ni—Pd bimetallic nanoparticle catalysts for C—C coupling reactions,” Catal. Sci. Technol., 2016, 6, 5567-5579 (“Rai 2016”).
Rai, R. K., et al. “Highly Active Bimetallic Nickel-Palladium Alloy Nanoparticle Catalyzed Suzuki-Miyaura Reactions,” Chem-CatChem, 2015, 7, 1806-1812 (“Rai 2015”).
Riggs, W. M., “X-ray photoelectron spectrometry of platinum compounds,” Anal. Chem., 1972, 44, 830-832 (“Riggs 1972”).
Romeo, M., et al., “Photoemission study of Pt adlayers on Ni(111),” Surf. Sci., 1990, 238, 163-168 (“Romeo 1990”).
Schluckebier, G. et al., “Investigations on demixing and crystallization behavior of metallic glasses of the system palladium-nickel-phosphorus,” Z. Met.kd., 1983, 74, 569-576 (“Schluckebier 1983”).
Schwarz, R. B., et al., in Properties of Complex Inorganic Solids. (eds. Gonis, A., et al.), Springer US, 1997, 287-299 (“Schwartz 1997”).
Sha, Z. D., et al., “Notch strengthening in nanoscale metallic glasses,” Acta Mater., 2019, 169, 147-154 (“Sha 2019”).
Shen, Y. Y., et al., “3D printing of large, complex metallic glass structures,” Mater. Des., 2017, 117, 213-222 (“Shen 2017”).
Sheng, H. W., et al., “Atomic packing and short-to-medium-range order in metallic glasses.,” Nature, 2006, 439, 419-425 (“Sheng 2006”).
Shi, Y., et al., “Site-specific electrodeposition enables self-terminating growth of atomically dispersed metal catalysts,” Nat. Commun., 2020, 11, 4558 (“Shi 2020”).
Takeuchi, A., et al., “Pd₂₀Pt₂₀Cu₂₀Ni₂₀P₂₀ high-entropy alloy as a bulk metallic glass in the centimeter,” Intermetallics, 2011, 19, 1546-1554 (“Takeuchi 2011”).
Takeuchi, A., et al., “Quantitative evaluation of critical cooling rate for metallic glasses,” Mater. Sci. Eng. A: Struct. Mater. Prop. Microstruct. Process., 2001, 304, 446-451 (“Takeuchi 2001”).
Wada, T., et al., “Preparation of Zr-based metallic glass nanowires and nanoparticles by selective etching,” Scr. Mater., 2007, 57, 901-904 (“Wada 2007”).
Wang, B., et al., “General synthesis of high-entropy alloy and ceramic nanoparticles in nanoseconds,” Nat. Synth., 2022, 1, 138-146 (“Wang 2022”).
Wang, W., et al., “General synthesis of amorphous PdM (M=Cu, Fe, Co, Ni) alloy nanowires for boosting HCOOH dehydrogenation,” Nano Lett., 2021, 21, 3458-3464 (“Wang 2021”).
Wang, Y. A., et al., “Syntheses and characterization of mercapto-hydroxyl-palladium macromolecular chelates and their catalytic properties,” J. Mol. Catal., 1988, 45, 127-142 (“Wang 1988”).
Wu, G., et al., “In-plane strain engineering in ultrathin noble metal nanosheets boosts the intrinsic electrocatalytic hydrogen evolution activity,” Nat. Commun., 2022, 13, 4200 (“Wu 2022”).
Yan, Q.-Q., et al., “Reversing the charge transfer between platinum and sulfur-doped carbon support for electrocatalytic hydrogen evolution,” Nat. Commun., 2019, 10, 4977 (“Yan 2019”).
Yan, W., et al., “Structured nanoscale metallic glass fibres with extreme aspect ratios,” Nat. Nanotechnol., 2020, 15, 875-882 (“Yan 2020”).
Yan, Y.-G., et al., “Overview: recent studies of machine learning in phase prediction of high entropy alloys,” Tungsten, 2023, 5, 32-49 (“Yan 2023”).
Yang, Y., et al., “Determining the three-dimensional atomic structure of an amorphous solid,” Nature, 2021, 592, 60-64 (“Yang 2021”).
Yao, Y., et al., “High-entropy nanoparticles: Synthesis-structure-property relationships and data-driven discovery,” Science, 2022, 376(6589), eabn3103 (“Yao 2022”).
Yao, Y., et al., “Computationally aided, entropy-driven synthesis of highly efficient and durable multi-elemental alloy catalysts,” Sci. Adv., 2020, 6, eaaz0510 (“Yao 2020”).
Yao, Y., et al., “Carbothermal shock synthesis of high-entropy-alloy nanoparticles,” Science, 2018, 359, 1489-1494 (“Yao 2018”).
Yu, F.-Y., et al., “Pt—O bond as an active site superior to Pt0 in hydrogen evolution reaction,” Nat. Commun., 2020, 11, 490 (“Yu 2020”).
Zeeshan, M. A., et al., “Electrochemically synthesized amorphous and crystalline nanowires: dissimilar nanomechanical behavior in comparison with homologous flat films,” Nanoscale, 2016, 8, 1344-1351 (“Zeeshan 2016”).
Zhang, Z., et al., “The simplest construction of single-site catalysts by the synergism of micropore trapping and nitrogen anchoring,” Nat. Commun., 2019, 10, 1657 (“Zhang 2019”).
Zhang, J., et al., “Single platinum atoms immobilized on an MXene as an efficient catalyst for the hydrogen evolution reaction,” Nat. Catal., 2018, 1, 985-992 (“Zhang 2018”).
Zhao, Y., et al., “Modulating Pt—O—Pt atomic clusters with isolated cobalt atoms for enhanced hydrogen evolution catalysis,” Nat. Commun., 2022, 13, 2430 (“Zhao 2022”).
Zhao, M., et al., “Fabrication of Pd—Ni—P metallic glass nanoparticles and their application as highly durable catalysts in methanol electro-oxidation,” Chem. Mater., 2014, 26, 1056-1061 (“Zhao 2014”).
Zhong, L., et al., “Formation of monatomic metallic glasses through ultrafast liquid quenching,” Nature, 2014, 512, 177-180 (“Zhong 2014”).

What is claimed is:

1. A method for synthesizing metallic glass nanoparticles, wherein the method comprises:
(a) mixing a metal/metalloid precursor with a material comprising carbon;
(b) performing a flash Joule heating process using the material mixed with the metal/metalloid precursor, wherein the metal/metalloid precursors are decomposed and fused into alloy melts; and
(c) rapidly cooling the alloy melts to vitrify the alloy melts into the metallic glass nanoparticles.

2. The method of claim 1, wherein the method comprises a kinetically controlled synthesis of the metallic glass nanoparticles.

3. The method of claim 1, wherein the step of mixing comprises dissolving the metal/metalloid precursor in a solvent to form a solution and wetting the material comprising the carbon with the solution.

4. The method of claim 3, wherein a phosphorous source is dissolved in the solvent when forming the solution.

5. The method of claim 4, wherein the phosphorous source is PPh₃.

6. The method of claim 3, wherein the step of wetting comprises impregnating the metal/metalloid precursor on the material comprising the carbon.

7. The method of claim 3, wherein the solvent is selected from the group consisting of alcohol, water, and mixtures thereof.

8. The method of claim 3, wherein the solvent comprises ethanol.

9. The method of claim 1, wherein the carbon in the material serves as a conductive additive and a supporting substrate in the flash Joule heating process.

10. The method of claim 1, wherein the material comprises carbon black.

11. The method of claim 1, wherein the metallic glass nanoparticles are Pd- and/or Pt-based metallic glass nanoparticles.

12. The method of claim 1, wherein the metallic glass nanoparticles are selected from the group consisting of PdNiP, PdCuP, PdCuNiP, PtNiP, PtCuP, PtCuNiP, and PdCuFeNiP metallic glass nanoparticles and combinations thereof.

13. The method of claim 1, wherein
(a) the metallic glass nanoparticles have the chemical formula M₁—M₂—P;
(b) M₁ is selected from the group consisting of Pt, Pd, and combinations thereof; and
(c) M₂ is selected from the group consisting of Cu, Ni, Fe. Co, Sn, and combinations thereof.

14. The method of claim 1, wherein the flash Joule heating process comprises providing millisecond current pulses through the metal/metalloid precursor at a heating rate of at least 10² K/s.

15. The method of claim 1, wherein the flash Joule heating process raises the temperature of the metal/metalloid precursors to at least 1800 K.

16. The method of claim 1, wherein the rapidly cooling is performed at an ultrafast rate of cooling of at least 10² K/s.

17. The method of claim 16, wherein the ultrafast rate of cooling is by thermal radiation.

18. The method of claim 1, wherein the metal/metalloid precursors are selected from the group consisting of H₂PtCl₆, PdCl₂, CuCl₂, NiCl₂, FeCl₃, PPh₃, P₂O₅, and combinations thereof.

19. The method of claim 1, wherein the metal/metalloid precursor comprises a metal salt.

20. The method of claim 19, wherein the metal salt is selected from the group consisting of H₂PtCl₆, PdCl₂, CuCl₂, NiCl₂, FeCl₃, and combinations thereof.

21. A composition comprising metallic glass nanoparticles made by the method of claim 1.

22. A method comprising using the composition of claim 21 as a catalyst, wherein the catalyst comprises the metallic glass nanoparticles.

23. The method of claim 22, wherein the metallic glass nanoparticles are used as catalysts for a hydrogen evolution reaction.

24. The method of claim 22, wherein the metallic glass nanoparticles are used as catalysts for clean H₂ production via water electrolysis.

25. The method of claim 22, wherein the metallic glass nanoparticles are used as catalysts for catalytic coupling.

26. The method of claim 25, wherein the catalytic coupling is of a boronic acid and an aryl halide.

27. The method of claim 25, wherein the catalytic coupling is Suzuki-Miyaura coupling or Miyaura-Heck coupling.

28. The method of claim 22, wherein the metallic glass nanoparticles comprise PtNiP metallic glass nanoparticles.

29. The method of claim 22, wherein the metallic glass nanoparticles comprise PdNiP metallic glass nanoparticles.

30. The method of claim 22, wherein the metallic glass nanoparticles are used as catalysts for a reaction selected from the group consisting of electrochemical reactions, hydrogen evolution reactions, oxygen reduction reactions, carbon dioxide reduction reactions, reactions used in fuel cells, carbon-carbon bond forming reactions, carbon hydrogen bond forming reactions, hydroformylation reactions, carbon monoxide insertion reactions, and reductive elimination reactions.
